(19) United States
(12) Patent Application Publication
(10) Pub. No.: US 2026/0295897 A1
(43) Pub. Date: Oct. 1, 2026

(54) WOOD PROCESSING SYSTEMS AND METHODS

(71) Applicant: Charles Wiebe, St. Louis, MO (US)

(72) Inventor: Charles Wiebe, St. Louis, MO (US)

(21) Appl. No.: 19/477,391

(22) PCT Filed: Apr. 25, 2024
(86) PCT No.: PCT/US2024/026268

§ 371 Date: Oct. 21, 2025

Related U.S. Application Data
(60) Provisional application No. 63/461,673, filed on Apr. 25, 2023.

(51) Int. Cl. B27M 1/08

(52) U.S. Cl. CPC B27M 1/08

(57) ABSTRACT

A wood processing system, components thereof, and associated methods. Elongate wood members are cut from a piece of wood such as a log. The elongate wood members may be cut in a plurality of adjacent rows. The elongate wood members in a row may each have a generally triangular cross-sectional shape. The generally triangular cross-sectional shape of the elongate wood members of a row may alternate in orientation along the row.

### CROSS-REFERENCE TO RELATED APPLICATION

This application claims priority to U.S. Provisional Patent Application No. 63/461,673, filed Apr. 25, 2023, which is hereby incorporated by reference in its entirety.

### FIELD

The present disclosure generally relates to wood processing systems and methods, and more particularly to systems and processes for reducing a supply of wood to smaller wood members more suitable for drying and finish processing.

### BACKGROUND

Various types of wood processing systems are used for reducing logs and other supplies of wood to smaller wood members. Before finish processing of wood members, such as to make the wood members into components to be used in construction (e.g., stair building components), the wood is usually dried, such as in a kiln. In general, such processes are often inefficient and result in wasted wood.

### SUMMARY

In one aspect, a method of processing wood comprises obtaining a piece of wood and cutting a first series of elongate wood members from the piece of wood in a first row. Each elongate wood member of the first series has first and second ends and a length extending therebetween. Each elongate wood member of the first series has a generally triangular cross-sectional shape. The method further comprises cutting a second series of elongate wood members from the piece of wood in a second row different from the first row. Each elongate wood member of the second series has first and second ends and a length extending therebetween. Each elongate wood member of the second series has a generally triangular cross-sectional shape.

In another aspect, a method of processing wood comprises obtaining a piece of wood, applying foam around the piece of wood for securing the piece of wood in position, and cutting the piece of wood to form a plurality of wood members from the piece of wood.

In another aspect, a wood processing system comprises a saw system configured to cut a first series of elongate wood members from the piece of wood in a first row. Each elongate wood member of the first series has first and second ends and a length extending therebetween. Each elongate wood member of the first series has a generally triangular cross-sectional shape. The saw system is configured to cut a second series of elongate wood members from the piece of wood in a second row different from the first row. Each elongate wood member of the second series has first and second ends and a length extending therebetween. Each elongate wood member of the second series has a generally triangular cross-sectional shape.

Other aspects and features of the present disclosure will be in part apparent and in part pointed out herein.

### BRIEF DESCRIPTION OF THE DRAWINGS

FIG. 1 is a perspective of a wood processing system of the present disclosure;

FIG. 2 is a front, right perspective of a gang ripper of the wood processing system;

FIG. 3 is a front, left perspective of the gang ripper;

FIG. 4 is a top perspective of the gang ripper;

FIG. 5 is another top perspective of the gang ripper;

FIG. 6 is a top view of the gang ripper;

FIG. 7 is a front view of the gang ripper;

FIG. 8 is a left view of the gang ripper;

FIG. 9 is a right view of the gang ripper;

FIG. 10 is a bottom perspective of the gang ripper;

FIG. 11 is another bottom perspective of the gang ripper;

FIG. 12 is a another bottom perspective of the gang ripper;

FIG. 13 is a front perspective of the gang ripper;

FIG. 14 is a perspective of the gang ripper being turned to reorient the gang ripper;

FIG. 15 is a rear perspective of the gang ripper after having been turned approximately 180 degrees to reorient the gang ripper;

FIG. 16 is a schematic end view of a log on a wood support of the wood processing system, the log having been cut by a first pass of the gang ripper;

FIG. 17 is a schematic end view of the log similar to FIG. 16 but showing the log after having been cut by a second pass of the gang ripper;

FIG. 18 is a schematic end view of the log similar to FIG. 17 but showing the log after having been cut by a slab saw of the wood processing system of the present disclosure; and

FIG. 19 is a perspective of ends of elongate wood members formed by cutting them from the log.

Corresponding reference characters indicate corresponding parts throughout the drawings.

### DETAILED DESCRIPTION

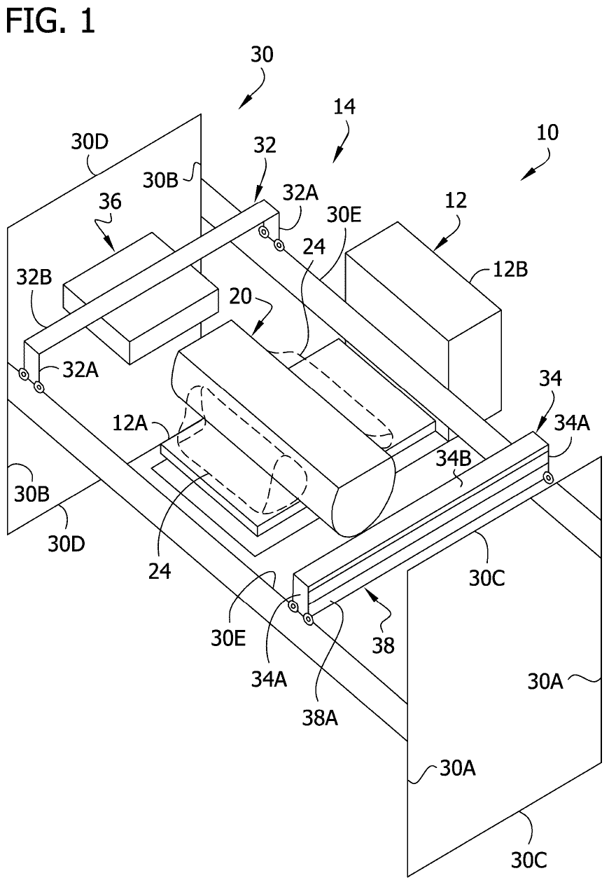

Referring to FIG. 1, a wood processing system 10 of the present disclosure generally includes a wood support 12 and a saw system 14. As explained in further detail below, the wood processing system 10 is configured to form a plurality of wood members (e.g., staves) by cutting a piece of wood. In the illustrated embodiment, the piece of wood is shown as a log 20, but it will be understood other pieces of wood, such as a board, a composite piece of wood (e.g., including wood and adhesive), etc., can be used without departing from the scope of the present disclosure.

In one example, the wood processing system 10 may be used to form elongate wood members 20A suitable for stacking, drying (e.g., in a kiln), processing, and/or use in wood construction (e.g., working and/or assembling for making stair or railing parts), such as disclosed in U.S. patent application Ser. No. 18/136,942, filed Apr. 20, 2023, the entirety of which is hereby incorporated by reference. It will be appreciated that the wood members may be used for other purposes without departing from the scope of the present disclosure.

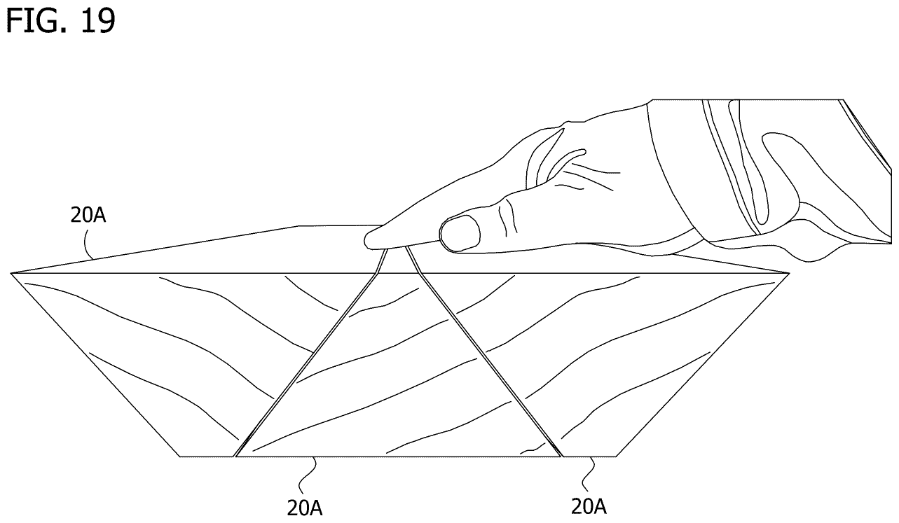

As shown in FIG. 19, the wood members 20A produced by the system can be elongate and can have a generally triangular cross-sectional shape. It will be appreciated that other sizes and shapes of resulting wood members can be cut from the source of wood without departing from the scope of the present disclosure. Moreover, it will be appreciated that the generally triangular shape of the cross section of the wood members can deviate from a perfect triangle (e.g., have one or more indentations or rounded or truncated corners) without departing from the scope of the present disclosure.

The wood support 12 comprises a wood holder 12A (e.g., platform, bed, etc.) and a lift 12B (e.g., elevator) configured to move the wood holder up and down. The wood support 12 can move the log upward to suitably locate the top of the log for being cut by the saw system. For example, after a layer (e.g., row) of elongate wood members 12A is removed from the log 12, the wood support 12 can lift the log to position the log for cutting subsequent layers (e.g., second, third, fourth, and more rows) of elongate members from the log.

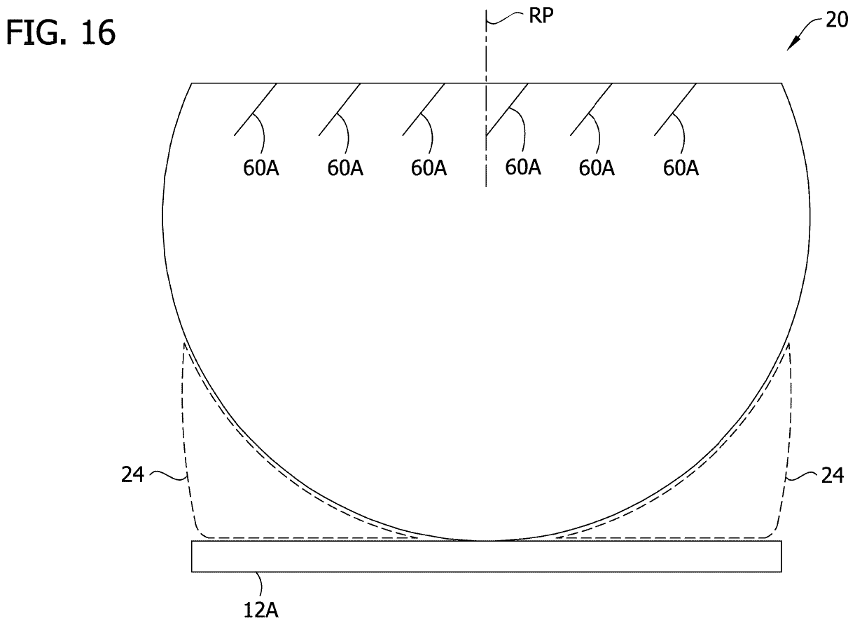

In one example, the log 20 can be secured in position (e.g., braced against rolling or rocking) on the wood holder by installation of foam 24 (broadly, hardenable or curable material) around the log. For example, the foam 24 may be applied to the left and right sides of the log 20 between the log and the wood holder 12A. Example foam 24 is shown in dashed lines in FIGS. 1 and 16. The foam could be an expanding polyurethane foam or another type of foam. In one example, the foam 24 is applied in an uncured or unhardened state to one or more segments of the log 20 and then permitted to cure or harden. When the foam is cured or hardened, the foam desirably adheres to the log and to the wood holder and is relatively rigid to prevent movement of the log relative to the wood holder. It will be appreciated that the foam can be readily cut by the saw system 14 and may be cut in the process of cutting elongate wood members from the log. The foam securing the log in position on the wood holder does not form an obstruction to cutting the log and desirably continues to hold the log in position on the wood holder even after multiple rows of wood members have been cut from the log and after substantial portions of the foam have been cut away in this process.

The saw system 14 includes a frame 30 (e.g., gantry support frame), a first gantry 32 moveable along the frame, a second gantry 34 moveable along the frame. A gang ripper 36 is supported by the first gantry 32. A slab saw 38 is supported by the second gantry 34. Other configurations can be used without departing from the scope of the present disclosure.

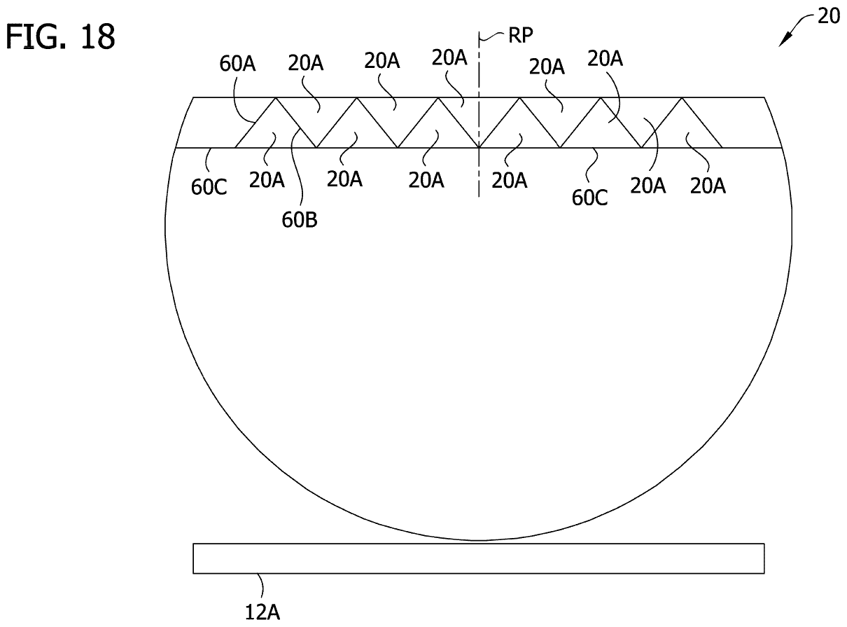

In one example use of the system, a log 20 (broadly, piece of wood) is supported on the wood support 12, cut by the gang ripper 36 in a first pass of the gang ripper, cut by the gang ripper in a second pass of the gang ripper, and then cut by a pass of the slab saw 38, to produce a series of elongate wood members 20A extending in a row widthwise of the log (e.g., see FIG. 18) and removable from the top of the log. The log remains stationary as the gantries 32, 34 move relative to the log. It will be appreciated that more or fewer saw passes may be used to cut a row of wood members 20A. Subsequent rows of wood members (e.g., second, third, fourth, etc.) may then be cut and removed in sequence after removal of the first row. In other embodiments, the log may move relative to one or more saws. For example, the wood support could comprise a conveyor.

The gantry support frame 30 includes two forward posts 30A, two rear posts 30B, a forward brace 30C connecting the two forward posts, a rear brace 30D connecting the two rear posts, and left and right tracks 30E spaced from each other and extending between respective left and right sets of forward and rearward posts. The first and second gantries 32, 34 are moveable along the left and right tracks 30E to permit saw passes along the length of the log.

The first gantry 32 has a home position at the rear end of the frame, and the second gantry 34 has a home position at the forward end of the frame. The gantries are movable forward/rearward along the frame 30 to work the log with the respective saws supported by the gantries. The frame 30 has a length sufficient to permit the gantries to move along the frame (e.g., one gantry toward the other gantry) to work the full length of the wood (e.g., log about 4.5 feet to about 5 feet long) with the respective saws.

The first gantry 32 comprises a gantry frame including left and right carriages 32A moveable along the respective left and right tracks 30E. The gantry frame comprises a bridge 32B extending between the two carriages configured to support the gang ripper 36.

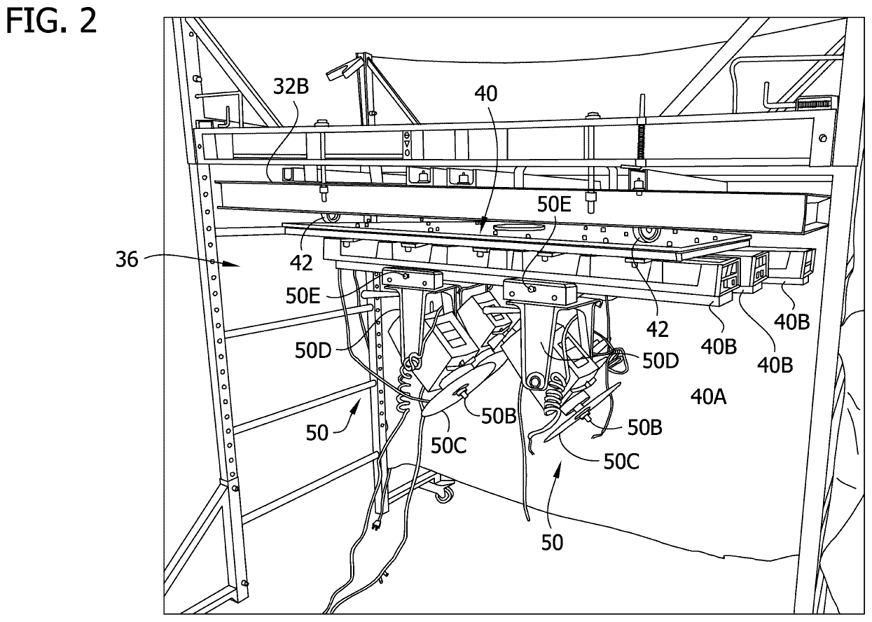

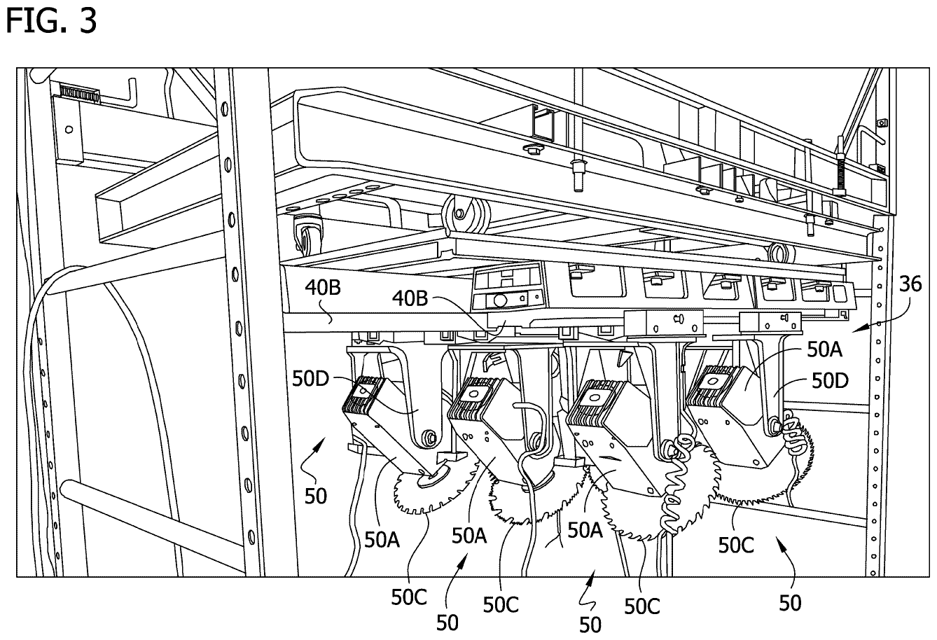

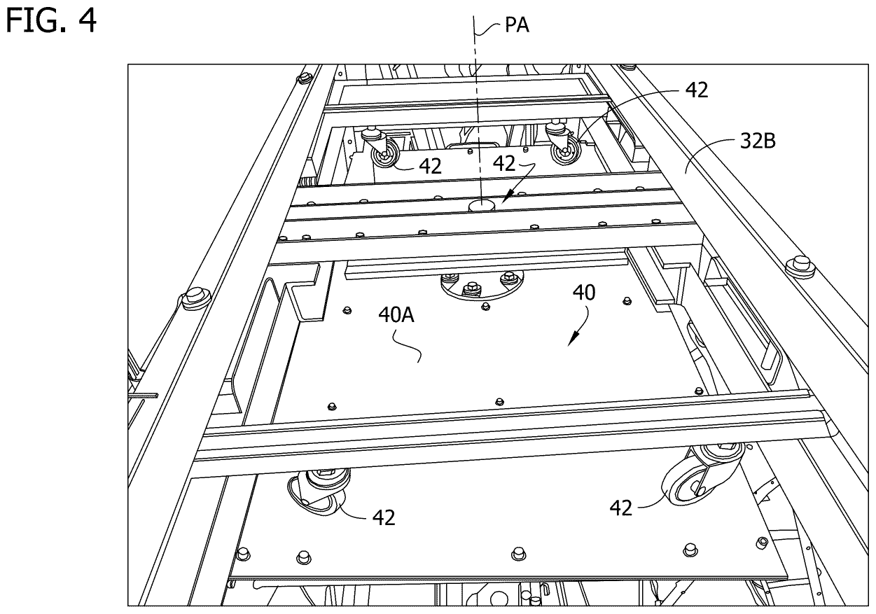

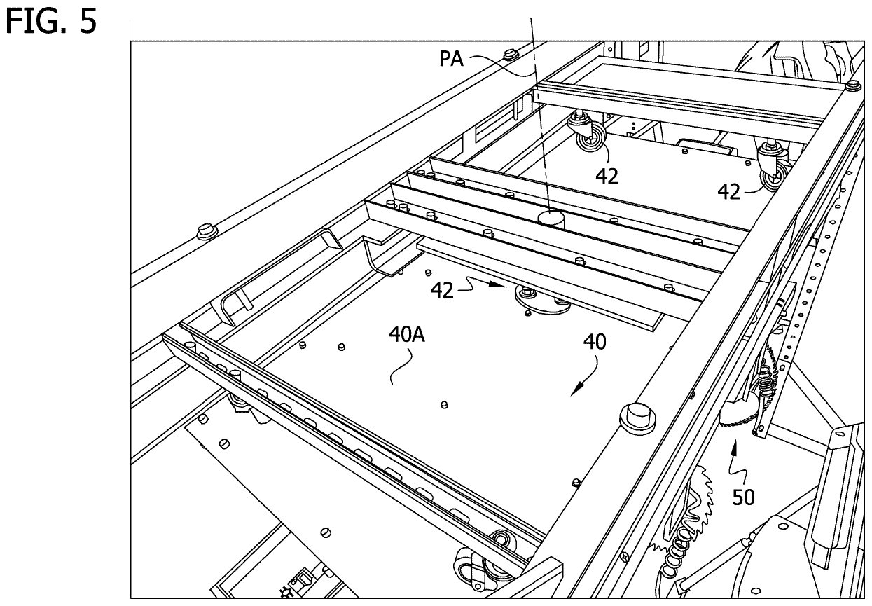

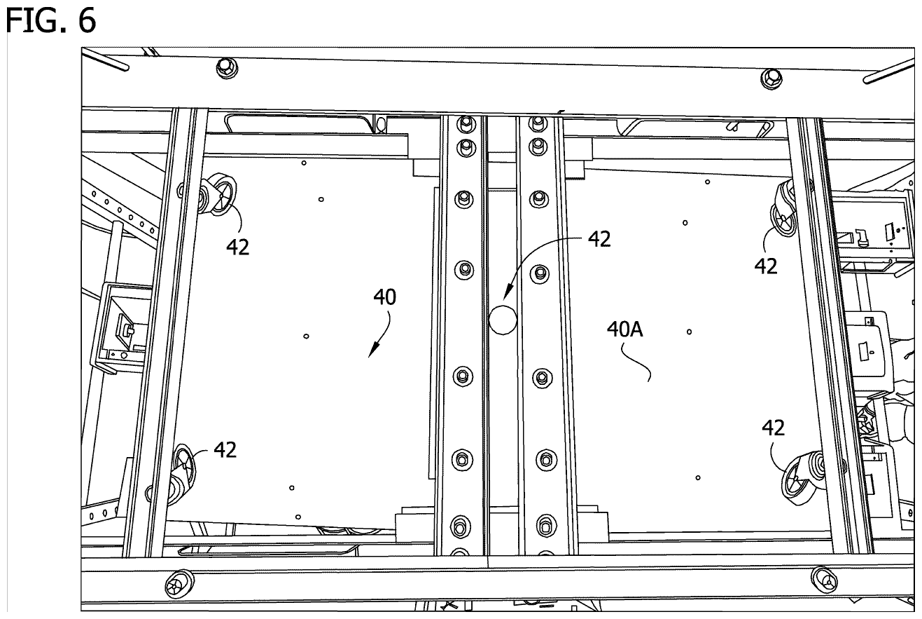

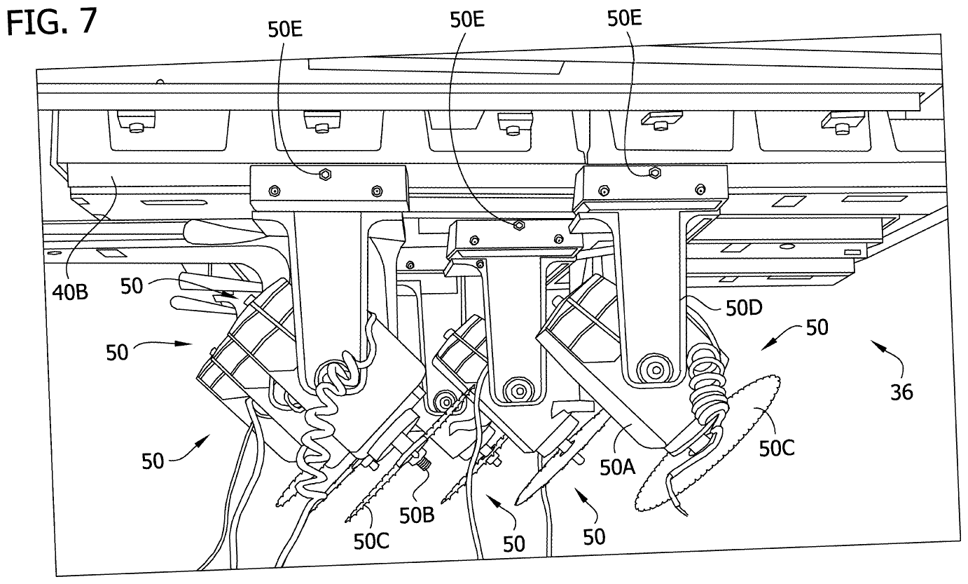

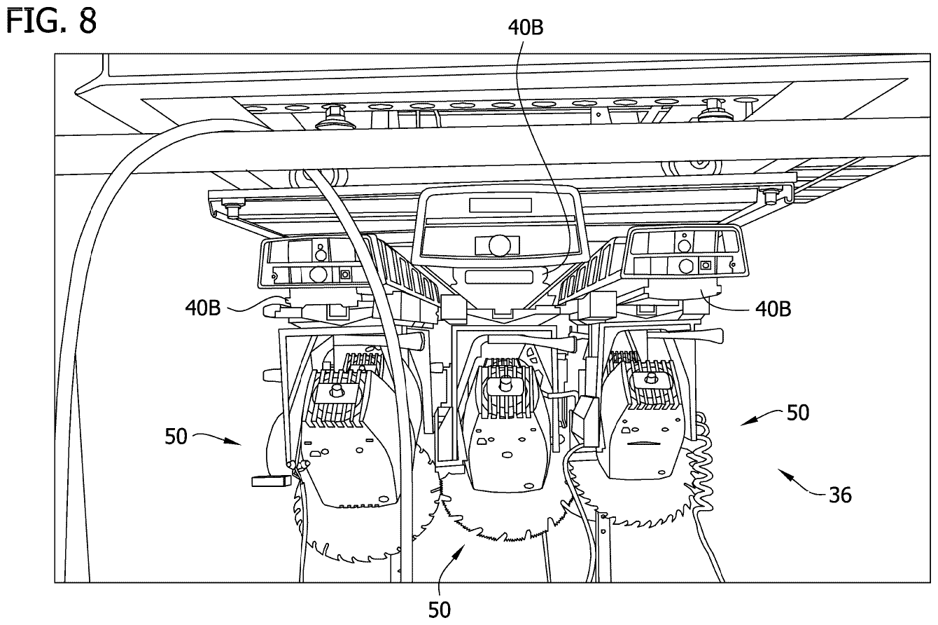

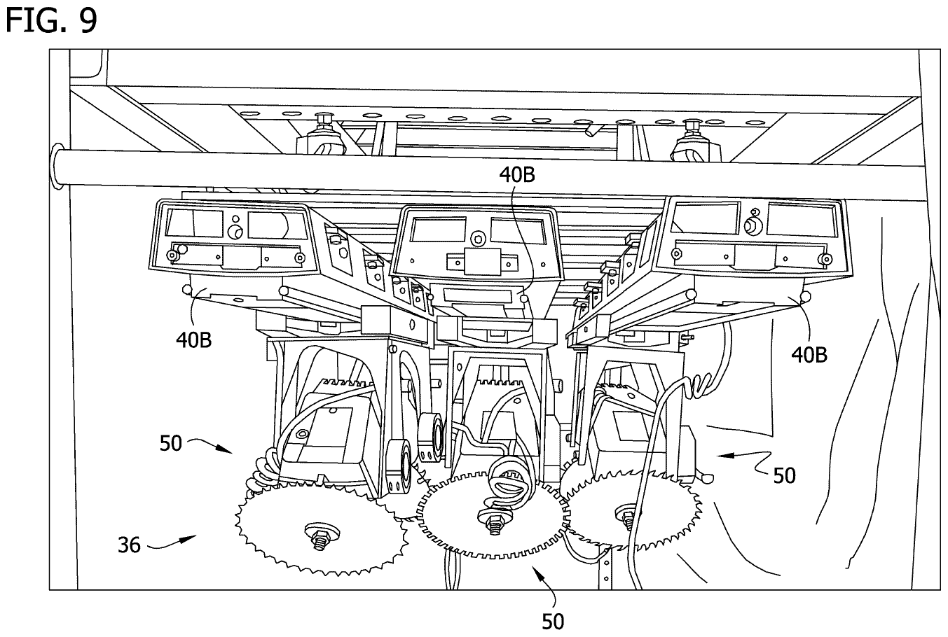

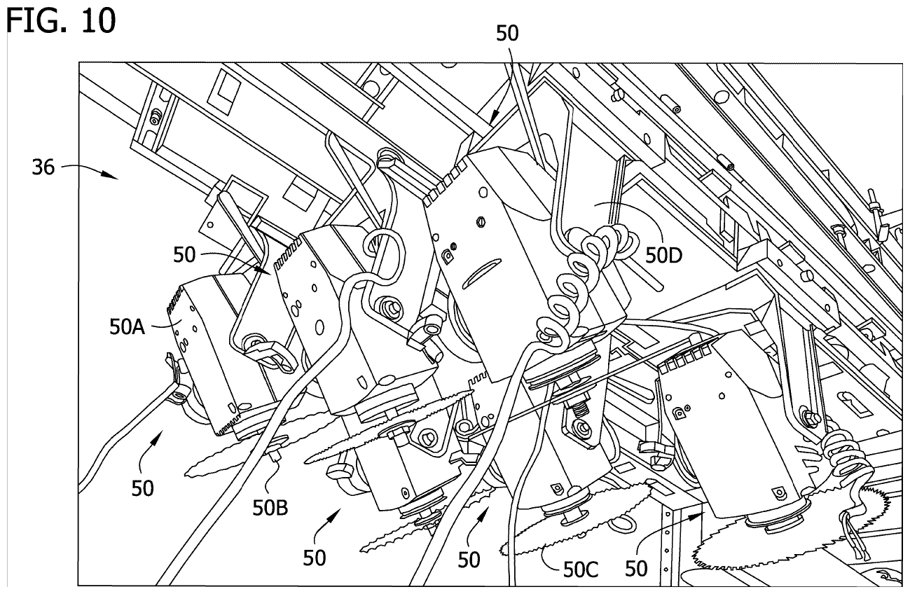

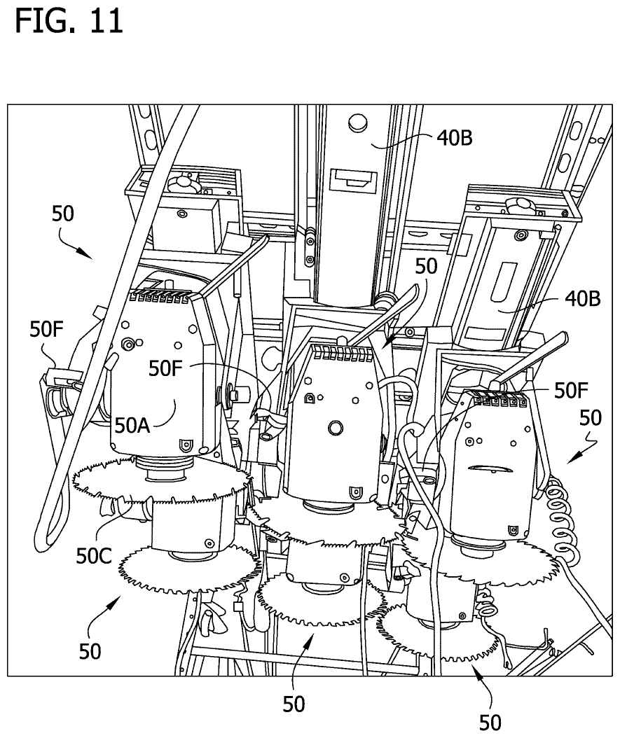

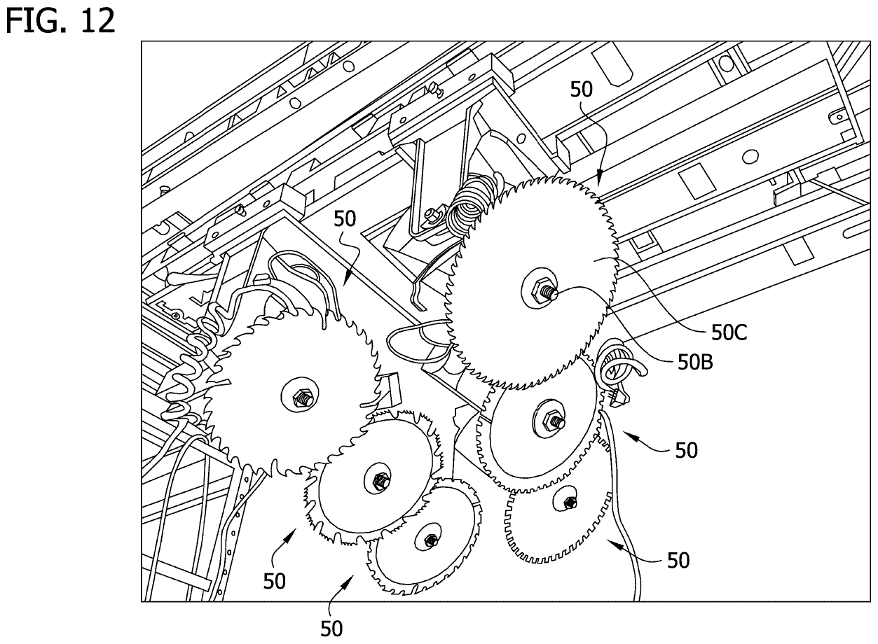

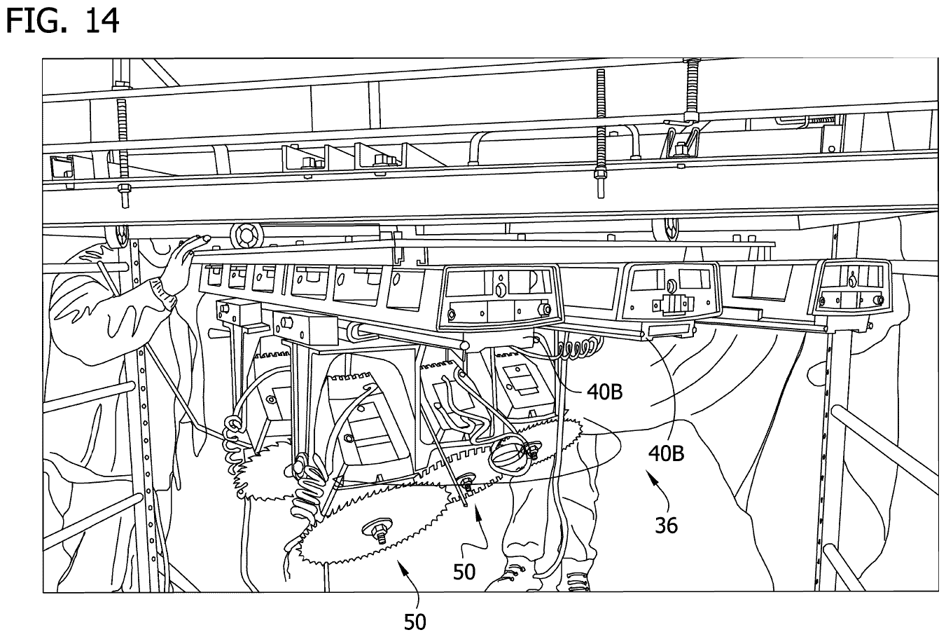

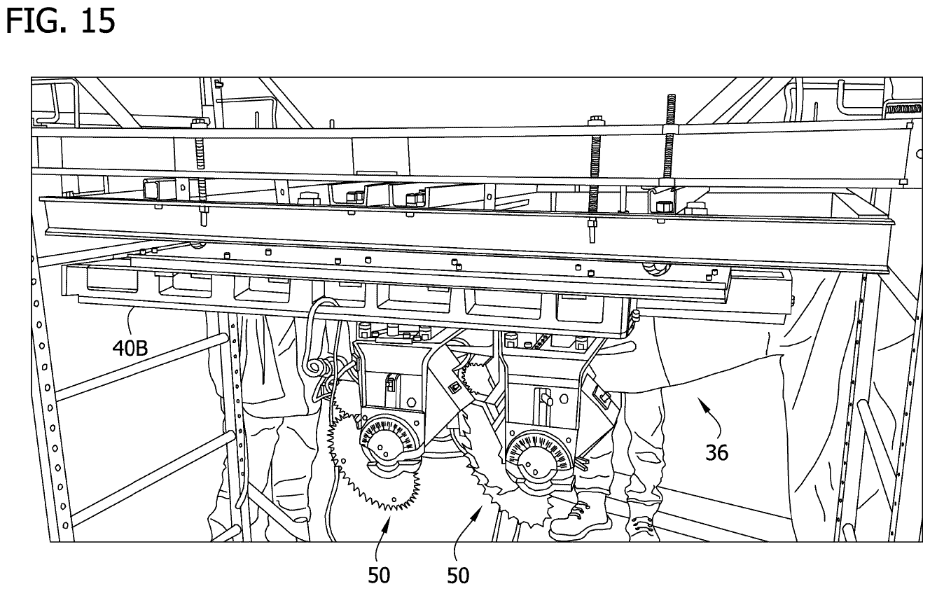

The gang ripper 36 is shown schematically in FIG. 1, and is shown in more detail in subsequent figures. In FIGS. 2-15, the gang ripper 36 is shown suspended from a cart, but it will be understood the gang ripper can be mounted on the gantry 32 as explained above.

The gang ripper includes a ripper saw assembly and a ripper saw assembly support 40. The ripper saw assembly support 40 is connected to the bridge 32B by a pivot connection 42 having a generally vertical pivot axis PA permitting the ripper saw assembly support to be rotated (e.g., 360 degrees, or at least 180 degrees) to change the orientation of the gang ripper saw assembly. In the example embodiment, the ripper saw assembly support 40 includes a hub 40A (e.g., steel plate) and three ripper saw tracks 40B connected to the hub. Four caster wheels 42 are arranged to roll on the top of the hub 40A to brace the hub to prevent forward/back and left/right swinging of the hub. The casters 42 are adjustable in length (e.g., threaded shaft adjustment) to assist with leveling the hub and thus the saw blades.

The gang ripper saw assembly includes multiple ripper saws 50. Six ripper saws 50 are shown in the illustrated example embodiment. Each ripper saw includes a saw head 50A including a saw motor and a shaft 50B rotatable by the saw motor. The shaft 50B is configured to have a circular saw blade 50C (broadly, blade) mounted thereon. Each ripper saw 50 also includes a saw body 50D including a carrier that is moveable left/right along a respective ripper saw track 40B to suitably position the saw in the array of saws. A retainer 50E is provided to maintain the position of the saw body along the track 40B, and the retainer is selectively releasable to permit movement of the saw body along the track. The saw head 50A is pivotably connected to the saw body 50D to permit a user to change an orientation of the shaft 50B and thus the saw blade 50C. A selectively releasable saw head retainer 50F is provided to permit selective pivoting of the saw head 50A and locking of the saw head in a desired orientation. In the example embodiment, all of the saw blades 50C are set to cut at an angle of about 45 degrees with respect to vertical for forming wood members having a generally triangular cross-sectional shape. The saws 50 are configured to cut the wood in spaced apart generally parallel cut paths at approximately equal spacing from each other at approximately the same cut angle (e.g., about 45 degrees plus or minus 5 degrees) with respect to vertical. However, it will be understood that other configurations (e.g., other angles) can be used without departing from the scope of the present disclosure.

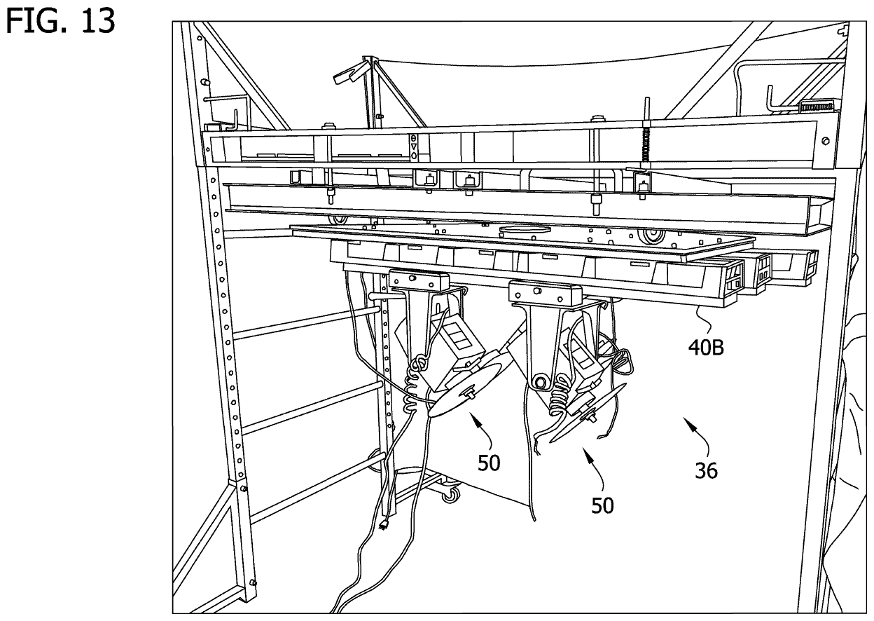

FIGS. 13-15 show a sequence of pivoting the gang ripper 36 about the pivot axis PA to change the orientation of the gang ripper 180 degrees. Such an operation could be performed after passing the gang ripper 36 down the log 20 in a first pass (away from the home position) to reorient the saw blades for passing the gang ripper down the log in a second pass (toward the home position).

The second gantry 34 comprises a gantry frame including left and right carriages 34A moveable along the respective left and right tracks 30E. The gantry frame comprises a bridge 34B extending between the two carriages 34A configured to support the slab saw 38. The slab saw 38 comprises a generally horizontal blade 38A having a chain thereon configured to cut the wood like a chain saw. It will be appreciated that the slab saw 38 could comprise a band saw instead of a chain saw. Moreover, one or more circular saws or other types of saws could be used as the slab saw.

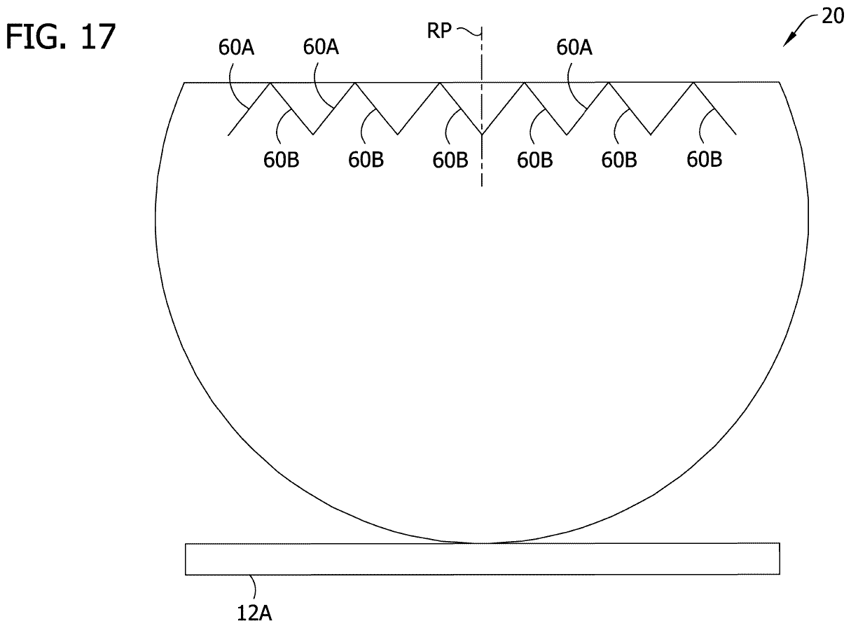

As shown schematically in FIG. 16, in a pass of the gang ripper 36 along the log 20, the saws make a series of cuts 60A along the top of the log extending across the row to form a first set of sides of the elongate wood members 20A. After the gang ripper 36 has passed the end of the log, the gang ripper can be turned about the pivot axis PA approximately 180 degrees to turn the gang ripper around. As shown schematically in FIG. 17, the gang ripper is then moved down the length of the log in a second pass back toward the home position of the gang ripper to make a second series of cuts 60B along the top of the log 20 extending across the row to form a second set of sides of the elongate wood members 20A. It will be appreciated that in the row of elongate wood members 20A, the generally triangular cross-sectional shape of the members alternates from a first orientation (e.g., nose up) to a second orientation (e.g., nose down) from one member to the next along the row extending across the log. An upper set of the elongate members 20A has noses pointing downward and is interleaved with a lower set of the elongate members 20A having noses pointing upward. In the second ripper pass, the upper elongate wood members (having noses pointing downward) may be released from the log due to their noses being released from the log. As shown schematically in FIG. 18, this process is followed by moving the slab saw 38 along the length of the log to cut a line or saw path 60C codirectional with the row (widthwise of the log 20, under the row of wood members 20A) to release the lower set of elongate wood members from the log (and optionally release the noses of the upper set of wood members).

After removal of the first row of elongate wood members, the wood support 12 raises the wood holder 12A and thus raises the log 20 to position the log for cutting a second row of wood members 20A. Passes of the gang ripper 36 and the slab saw 38 are performed in a similar manner as described above for cutting the second row of elongate wood members. After the second row of elongate wood members is removed, the process can be repeated for cutting and removing third, fourth, fifth, etc. rows of elongate wood members.

Desirably, one of the ripper blades 50C is oriented such that the bottom of its cut path intersects a reference plane RP including the generally vertical pivot axis PA about which the gang ripper is pivotable, and the bottom of the cut path terminates approximately at its intersection with the reference plane RP. It will be appreciated that because of this arrangement, when the gang ripper 36 is pivoted 180 degrees for a second pass along the long, that blade is positioned to cut a second side of an elongate member 20A providing it with two sides at generally 90 degree angle to form a generally triangular cross-sectional shape, without cutting farther down into the log of what will be the next layer (row) of elongate members. Likewise, the other saw blades 50C when pivoted 180 degrees about the vertical pivot axis are located to cut second sides of other elongate members to form similar triangular cross-sectional shapes.

Other orientations can be used for the ripper saw blades 50C. For example, a first set of blades can be oriented to be in generally parallel cut paths at about 45 degrees with respect to vertical, and a second set of blades can be oriented to be in generally parallel cut paths about 90 degrees with respect to the first set of blades. For example, a first blade angled to cut a first side of a wood member can be followed by a second blade angled to cut the other side of the wood member. Additional sets of blades can be similarly configured for cutting additional wood members in the row. Such a configuration may enable cutting generally triangular shaped wood members of a row in a single pass of the gang ripper rather than two passes. Other configurations (e.g., angles, etc.) can be used without departing from the scope of the present disclosure. For example, two or more of the ripper saw blades can be mounted on a common shaft rather than separate saw heads. Moreover, rows of elongate wood members can be upstanding or vertical rows rather than horizontal rows.

In another variation, the gang ripper 36 can be moveable left-to-right with respect to its gantry. Such movement may permit the gang ripper to cut wider logs that may have a width greater than a width of the cutting pattern of the gang ripper. In such a manner, the cut pattern can be moved left-to-right relative to the log to perform cuts along the full width of the log.

In some embodiments, the slab saw 38 may be supported by the same gantry as the gang ripper 36 to follow the gang ripper in a single gantry pass (e.g., in which the gang ripper includes angled saw blades to cut both sides of the generally triangular cross-sectional shape). Other configurations can be used.

Moreover, it will be appreciated the processing system may be configured to move the log relative to the saws, rather than to move the saws relative to the log, without departing from the scope of the present disclosure.

In view of the above, it will be appreciated that this disclosure is directed to systems and associated components and methods for processing wood. In one example, a log may be sawn to form multiple wood members that can then be stacked and dried in the stack prior to further processing and assembly of the wood members into products, such as components of a railing system.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A method of processing wood, the method comprising:
obtaining a piece of wood;
cutting a first series of elongate wood members from the piece of wood in a first row, each elongate wood member of the first series having first and second ends and a length extending therebetween, each elongate wood member of the first series having a generally triangular cross-sectional shape; and
cutting a second series of elongate wood members from the piece of wood in a second row different from the first row, each elongate wood member of the second series having first and second ends and a length extending therebetween, each elongate wood member of the second series having a generally triangular cross-sectional shape.

2. The method of claim 1, wherein the generally triangular cross-sectional shape of the elongate wood members of the first series alternates along the first row between a first orientation and a second orientation.

3. The method of claim 2, wherein the generally triangular cross-sectional shape of the elongate wood members of the second series alternates along the second row between the first orientation and the second orientation.

4. The method of claim 3, wherein the piece of wood has a length, a height, and a width, and the first row extends widthwise of the piece of wood.

5. The method of claim 4, wherein the second row extends widthwise of the piece of wood.

6. The method of claim 2, wherein the second row is below the first row.

7. The method of claim 6, further comprising removing the first series of elongate wood members from the piece of wood before said cutting the second series of elongate wood members from the piece of wood.

8. The method of claim 1, further comprising cutting a third series of elongate wood members from the piece of wood in a third row different from the second row, each elongate wood member of the third series having first and second ends and a length extending therebetween, each elongate wood member of the third series having a generally triangular cross-sectional shape.

9. The method of claim 8, wherein the piece of wood has a length, a height, and a width, and the first row extends widthwise of the piece of wood, the second row extends widthwise of the piece of wood below the first row, and the third row extends widthwise of the piece of wood below the third row.

10. The method of claim 8, wherein the generally triangular cross-sectional shape of the elongate wood members of the third series alternates along the third row between a first orientation and a second orientation.

11. The method of claim 10, further comprising removing the first series of elongate wood members from the piece of wood and removing the second series of elongate wood members from the piece of wood before said cutting the third series of elongate wood members.

12. The method of claim 1, wherein cutting the first series of elongate wood members comprises making a plurality of cuts into the piece of wood across the first row and making at least one cut co-directional with the first row.

13. The method of claim 12, further comprising maintaining the piece of wood in position while moving at least one saw relative to the piece of wood for making the plurality of cuts into the piece of wood across the row.

14. The method of claim 12, wherein making the plurality of cuts into the piece of wood across the first row comprises moving a gang of saw blades along a length of the piece of wood.

15. The method of claim 14, wherein making the plurality of cuts into the piece of wood across the first row comprises, after moving the gang of saw blades along the length of the piece of wood, reorienting the gang of saw blades with respect to the piece of wood and again moving the gang of saw blades along the length of the piece of wood.

16. The method of claim 12, wherein making the plurality of cuts into the piece of wood across the first row comprises cutting the piece of wood at a first angle across the first row and at a second angle across the first row.

17. The method of claim 1, wherein cutting the first series of elongate wood members comprises cutting the piece of wood with a plurality of circular saw blades.

18. The method of claim 16, wherein cutting the first series of elongate wood members further comprises cutting the piece of wood with a chain saw or a band saw.

19. A method of processing wood, the method comprising:
obtaining a piece of wood;
applying foam around the piece of wood for securing the piece of wood in position;
cutting the piece of wood to form a plurality of wood members from the piece of wood.

20. A wood processing system comprising:
a saw system configured to cut a first series of elongate wood members from the piece of wood in a first row, each elongate wood member of the first series having first and second ends and a length extending therebetween, each elongate wood member of the first series having a generally triangular cross-sectional shape, and the saw system configured to cut a second series of elongate wood members from the piece of wood in a second row different from the first row, each elongate wood member of the second series having first and second ends and a length extending therebetween, each elongate wood member of the second series having a generally triangular cross-sectional shape.
